(19) United States
(12) Patent Application Publication
(10) Pub. No.: US 2025/0156487 A1
(43) Pub. Date: May 15, 2025

(54) PROVIDING A USER-TAILORED ANSWER TO A QUERY FROM A UE OPERATING ON A WIRELESS TELECOMMUNICATION NETWORK

(71) Applicant: T-Mobile USA, Inc., Bellevue, WA (US)

(72) Inventor: Phi Nguyen, Lacey, WA (US)

(21) Appl. No.: 18/507,021

(22) Filed: Nov. 10, 2023

(51) Int. Cl. G06F 16/9535; G06F 16/9538; G06N 3/0455; G06Q 30/0251; H04M 3/51; H04M 3/523

(52) U.S. Cl. CPC G06F 16/9535; G06F 16/9538; G06N 3/0455; G06Q 30/0267; H04M 3/5191; H04M 3/5238

(57) ABSTRACT

The system obtains network information by creating an index of network websites and obtains UE contextual information including: cell tower ID serving the UE, technical capability of the UE, UE performance information, updates to the UE, UE browsing history, and site deployment information. The system obtains from the UE a natural language query and provides the query, the network information, and the UE contextual information to an AI. The system obtains from the AI an answer to the natural language query, where the answer is a summary of a relevant website. Based on the UE contextual information, the system determines whether a user of the UE is technologically savvy or not technologically savvy. If the user is technologically savvy, the system presents the answer and a link to the relevant website; otherwise, the system offers to connect the user to an operator of the network.

### BACKGROUND

Traditionally, company websites offer search functionality to present information to users and allow them to filter through the content to find answers on their own. However, this content may be duplicated, outdated, or insufficient, which can lead to increased user confusion, frustration among customers, and a higher volume of calls to customer support.

### BRIEF DESCRIPTION OF THE DRAWINGS

Detailed descriptions of implementations of the present invention will be described and explained through the use of the accompanying drawings.

FIG. 1 is a block diagram that illustrates a wireless telecommunication network in which aspects of the disclosed technology are incorporated.

FIG. 2 is a block diagram of an example transformer.

FIG. 3 shows an overview of a system to provide a tailored answer to a search query to a user.

FIG. 4 shows a system to perform a customized search based on the user query.

FIG. 5 shows a process by which a large language model (LLM) acquires knowledge about a network before responding to user searches.

FIG. 6 shows a process to gather detailed user information and provide an answer to the user.

FIG. 7 shows a process to evaluate webpages and code associated with the network.

FIG. 8 is a flowchart of a method to provide a user-tailored answer to a query from a user equipment (UE) operating on a wireless telecommunication network.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed here are a system and method to provide a user-tailored answer to a query from a mobile device operating on a wireless telecommunication network. The system obtains information associated with the wireless telecommunication network by creating an index of multiple websites associated with the wireless telecommunication network. Further, the system obtains contextual information associated with the mobile device including: cell tower identifier (ID) serving the mobile device, technical capability of the mobile device, performance information associated with the mobile device, updates to the mobile device, browsing history associated with the UE, and site deployment information associated with the wireless telecommunication network. Performance information can include processor usage and/or memory usage. Technical capability of the mobile device can include make and model of the mobile device, hardware upgrades to the mobile device, and software updates. Site deployment information can include planned hardware and software changes to the wireless telecommunication network.

The system obtains from the mobile device a natural language query and provides the query, the information associated with the wireless telecommunication network, and the contextual information associated with the mobile device to a large language model. The system obtains from the large language model an answer to the natural language query, where the answer is a summary of a relevant website among the multiple websites associated with the wireless telecommunication network. Based on the contextual information associated with the mobile device, the system determines whether a user associated with the UE is technologically savvy or not technologically savvy. Upon determining that the user is technologically savvy, the system presents the answer to the natural language query and a link to the relevant website among the multiple websites associated with the wireless telecommunication network. Upon determining that the user is not technologically savvy, the system offers to connect the user to an operator of the wireless telecommunication network. The operator can be an artificial intelligence (AI).

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

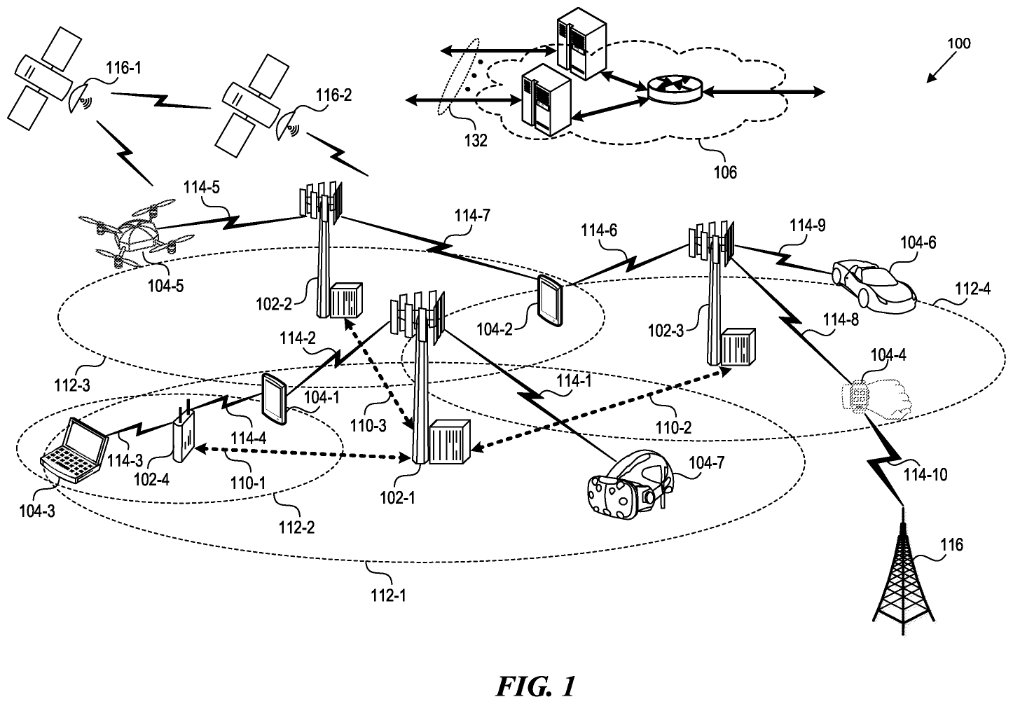

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Transformer

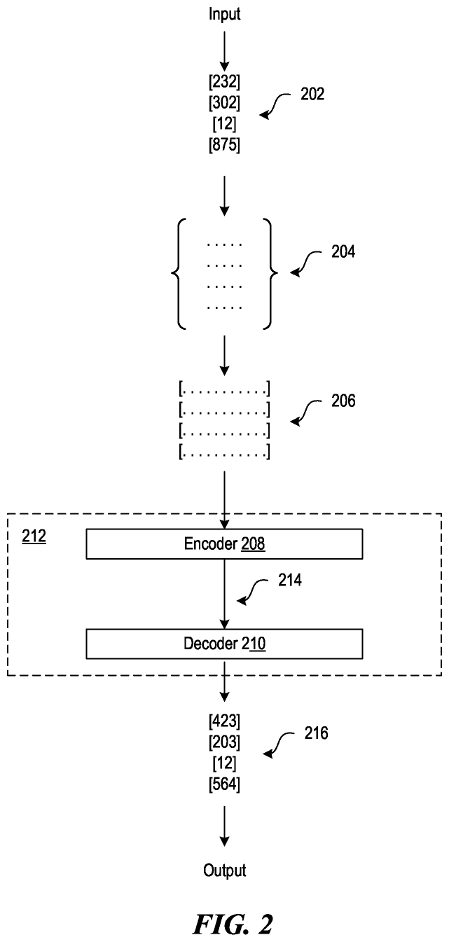

FIG. 2 is a block diagram of an example transformer 212. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 212 includes an encoder 208 (which can comprise one or more encoder layers/blocks connected in series) and a decoder 210 (which can comprise one or more decoder layers/blocks connected in series). Generally, the encoder 208 and the decoder 210 each include a plurality of neural network layers, at least one of which can be a self-attention layer. The parameters of the neural network layers can be referred to as the parameters of the language model.

The transformer 212 can be trained to perform certain functions on a natural language input. For example, the functions can include summarizing existing content, brainstorming ideas, writing a rough draft, fixing spelling and grammar, and translating content. Summarizing can include extracting key points from existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 212 is trained to perform certain functions on input formats other than natural language input. For example, the input can include objects, images, audio content, video content, or a combination thereof.

The transformer 212 can be trained on a text corpus that is labeled (e.g., annotated to indicate verbs, nouns, etc.) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 2 illustrates an example of how the transformer 212 can process textual input data. Input to a language model (whether transformer-based or otherwise) typically is in the form of natural language that can be parsed into tokens. It should be appreciated that the term “token” in the context of language models and natural language processing (NLP) has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph, etc.), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for simplicity. In general, the token sequence that is inputted to the transformer 212 can be of any length up to a maximum length defined based on the dimensions of the transformer 212. Each token 202 in the token sequence is converted into an embedding vector 206 (also referred to simply as an embedding 206). An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a [write] token, an [a] token, and a [summary] token when tokenized, the embedding 206 corresponding to the [write] token will be closer to another embedding corresponding to the [jot down] token in the vector space as compared to the distance between the embedding 206 corresponding to the [write] token and another embedding corresponding to the [summary] token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some examples, the numerical value of the token 202 can be used to look up the corresponding embedding in an embedding matrix 204 (which can be learned during training of the transformer 212).

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as the latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 is able to generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some examples, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to a question, text associated with a request, or a list of ideas associated with a request. For example, the input can include the question “What is the weather like in Australia?” and the output can include a description of the weather in Australia. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and Generative Pre-trained Transformers (GPT)-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an application programming interface (API)). Additionally or alternatively, such a remote language model can be accessed via a network such as, for example, the internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

An input to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

Providing a User-Tailored Answer to a Query from a UE Operating on a Wireless Telecommunication Network

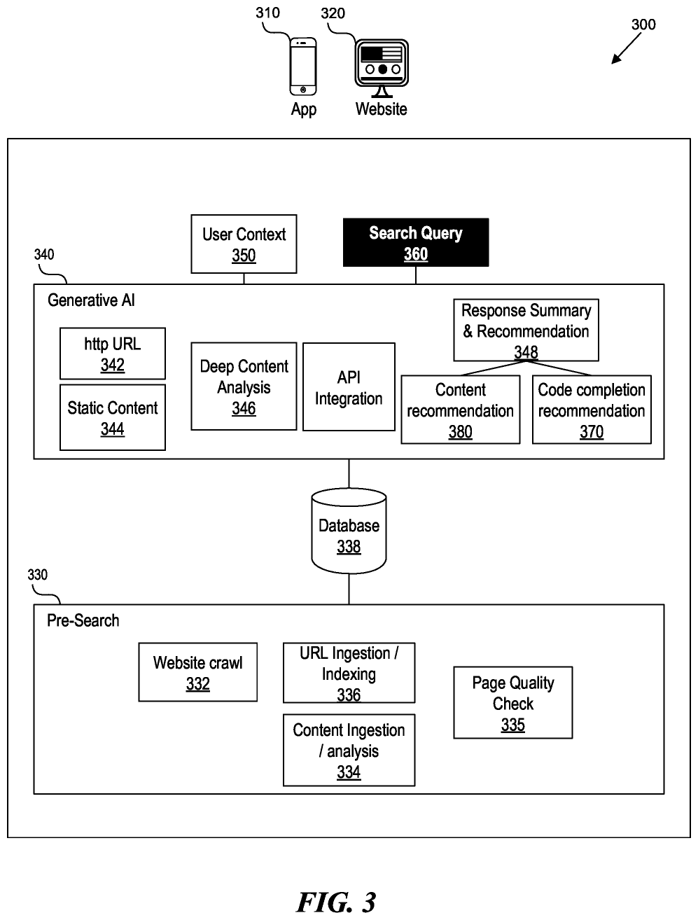

FIG. 3 shows an overview of a system to provide a tailored answer to a search query to a user. A user can use a UE such as a mobile device 310, a desktop computer 320, etc., to search for information associated with the network 100 in FIG. 1. To provide a tailored, relevant answer to the search query, the system 300 can perform a pre-search 330. During the pre-search 330, the system 300 does a website crawl 332. Consequently, the system 300, performs content ingestion/analysis 334 of the content of the website crawl 332, and performs URL ingestion/indexing 336. URL ingestion/indexing 336 is a process whereby the system 300 organizes and stores content obtained during the website crawl 332 in a database 338. The content is categorized and organized so that the information retrieval in response to the query is considerably faster. The system 300 can perform a page quality check 335 to determine whether the information is effectively presented in the page, whether it's a duplicate, etc.

The generative artificial intelligence (AI) 340 can obtain user context 350, the indexed information from the database 338, and a query 360 from the user. By considering the user context 350, the generative AI 340 provides an answer relevant and tailored to the user. The generative AI 340, based on the user context 350, the indexed information from the database 338, and the query 360, can identify the universal resource locator (URL) 342 and/or the static content 344 responsive to the query 360. The generative AI 340 can perform a deep content analysis 346 of the URL 342 and/or the static content 344 to generate a response summary and recommendation 348.

The response summary and recommendation 348 can include a summary of the content and a content recommendation 380, such as a link to further explore the response. In addition, depending on the question, the response summary and recommendation 348 can include a code completion recommendation 370. For example, if the query asked for a code to implement bubble sort in Python, the code completion recommendation 370 can include the appropriate Python code.

The response summary and recommendation 348 can also include a suggestion of a next step to perform, based on the user context 350. For example, the user context 350 can indicate that the user is interested in a certain phone or rate plan, either because the user is searching for new phones or different rate plans or because the user is searching for solutions to phone problems. Instead of producing an answer explaining the manual steps to perform to obtain a new phone or a new rate plan, the system 300 can offer to perform all the steps to obtain the new phone or the new rate plan.

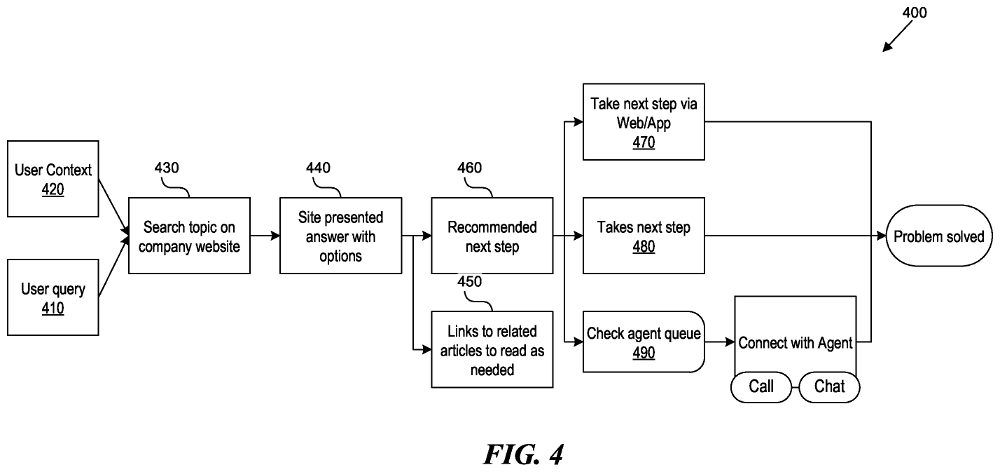

FIG. 4 shows a system to perform a customized search based on the user query. The system 400 receives the user query 410 and user context 420 and searches the topic on the website 430 of the network 100 in FIG. 1. The system 400 presents the answer 440 to the user query 410 as a summary of the answer, along with links 450 to related articles. In addition, the summary of the answer can include a recommended next step 460.

For example, the user context 420 can include user search history which indicates that the UE is experiencing slowness. The next step 460 can provide several options such as buying a new UE, uninstalling an application on the UE, changing the UE battery, etc.

The system 400 can offer links or applications to the user to perform the next step in option 470, can offer to the user to automatically perform the next step in option 480, or can offer to the user to connect with an operator of the network in option 490. If the user selects option 490, the system 400 can check the operator call or chat queue, and based on which queue requires less waiting time, the system can connect the user to the operator via a call or a chat.

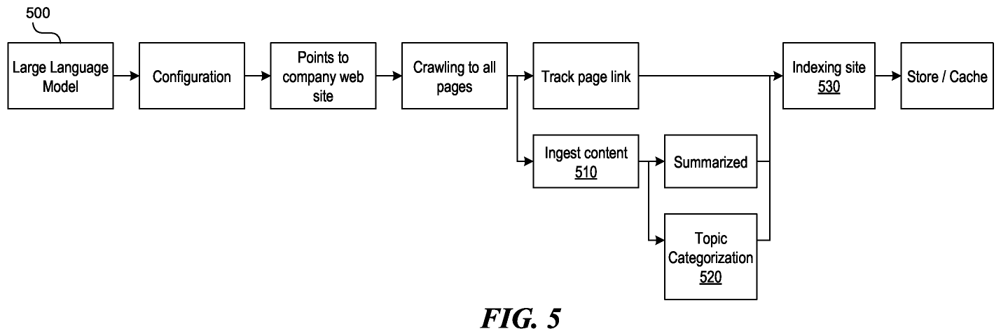

FIG. 5 shows a process by which a large language model (LLM) acquires knowledge about network 100 in FIG. 1 before responding to user searches. This process involves the LLM 500 traversing the entire network 100 website, much like a user manually clicking through all the links and reading the content on each page. As explained in this application, the LLM 500 is a machine learning model designed to ingest, in step 510, various content types; categorize them, in step 520, into distinct topics; map each page to its URL; and index the content, in step 530, to provide faster search responses. The LLM 500 can also generate summaries of the content, eliminating the need for users to read entire pages. This summarization capability becomes particularly valuable in recommendations when the LLM 500 has access to user context, enabling the LLM 500 to tailor the right recommendations to each user's profile, as described in this application.

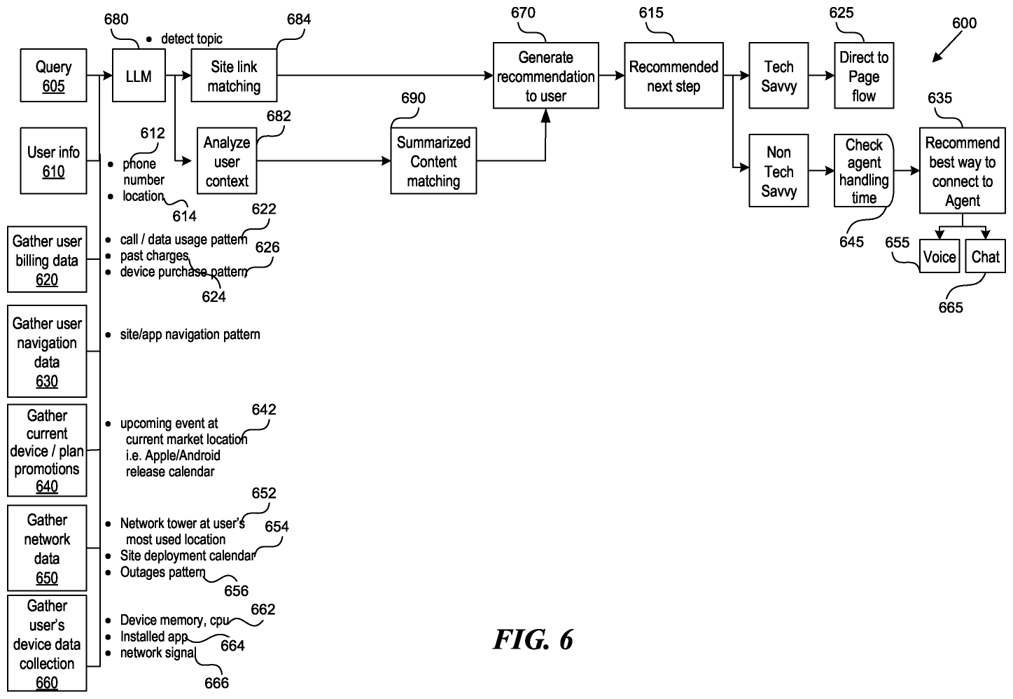

FIG. 6 shows a process to gather detailed user information and provide an answer to the user. The system 600 gathers user information 610, user billing data 620, user navigation data 630, current promotions 640, network data 650, and UE data 660.

User information 610 can include phone number 612 and location 614. User billing data 620 can include number of lines in the same plan, or usage pattern 622 such as voice usage pattern and data usage pattern, past charges 624 associated with the UE, and device purchase pattern 626, such as how often the user operates the UE. The usage patterns 622 can indicate how much the user texts, consumes video, or plays video games.

The user navigation data 630 includes previous searches that the user has performed within or outside the network 100 website. For example, the user may have searched for reasons why the phone is slow or the battery is draining.

The current promotions 640 can include upcoming events 642 at current market locations. For example, the user location 614 can indicate where the user is, and the upcoming events 642 can indicate an upcoming release of a new iPhone, or an upcoming promotion associated with the Super Bowl at the user's location 614. Consequently, the system 600 in step 670 can offer the relevant advertisement, e.g. promotion, to the user.

Network data 650 can include identifier of a cell tower 652 most frequently serving the UE, site deployment calendar 654, and outages pattern 656. For example, the user can indicate by the search query 605 that the UE is very slow, and the system 600 can obtain a notification that the cell tower 652 is overloaded, or malfunctioning. Consequently, the system 600 can inform the user that the problem is due to the network 100 as opposed to the UE. The site deployment calendar 654 can indicate upgrades to the network such as changes to the software or hardware. The changes to the software or hardware can also affect the speed of the UE, and if the user is experiencing slowness, the system 600 can determine the root cause of the slowness by having access to the site deployment calendar 654. Similarly, the outages pattern 656 indicates when certain parts of the network are malfunctioning, and potentially affecting the UE.

The UE data 660 can indicate technical capability of the UE such as the UE memory size, processor speed 662, performance information associated with the UE, updates to the UE, make and model of the UE, software applications 664 installed on the UE and the times of the software application installations, strength of network signal 666 at the UE, etc. For example, the user navigation data 630 can indicate the user has searched for reasons why the battery is draining. The software applications 664 installed on the UE and the times of the software application installations can indicate that the UE recently installed a particular software application. The website associated with the network 100 can also indicate that the particular software application can cause the battery to drain. Consequently, the system 600 in step 670 can recommend to the user to either uninstall the application or stop the application from running on the UE.

The LLM 680 can analyze user context 682 and match indexed sites 684 to the user context. In step 690, the LLM 680 can provide summarized content, and in step 670, the system 600 can generate recommendations to the user. In step 615, the system 600 can recommend the next step. Further, the system 600 can determine whether the user is tech savvy or not tech savvy. In step 625, if the user is tech savvy, the system 600 can direct the user to a webpage. In step 635, if the user is not tech savvy, the system 600 can direct the user to an agent. Prior to connecting to an agent, the system 600 can, in step 645, check agent handling times, and direct the user to the best way to connect to the agent based on the least waiting time, such as voice 655 or chat 665.

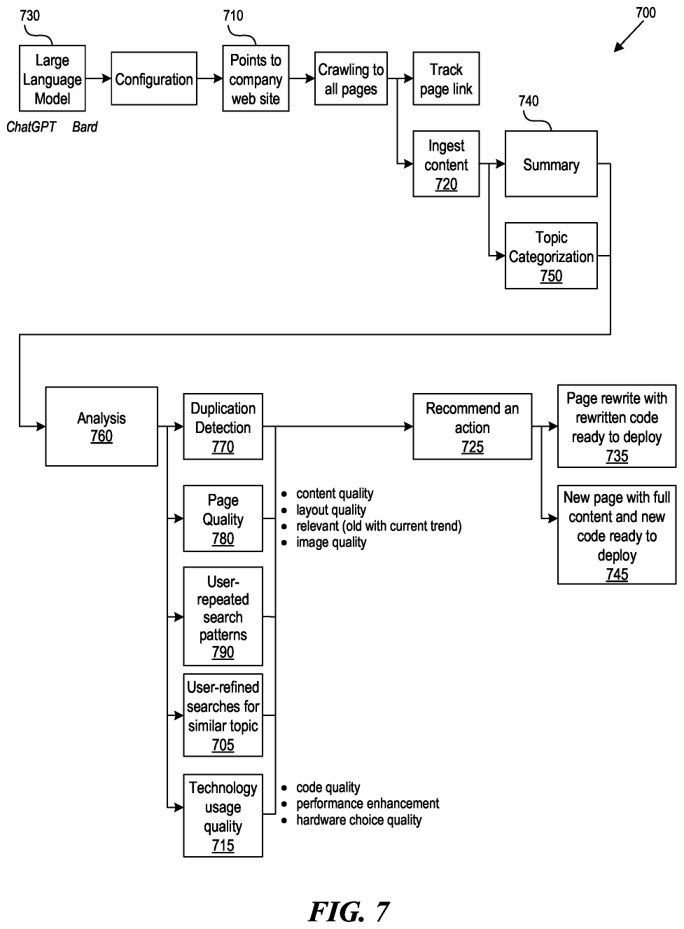

FIG. 7 shows a process to evaluate webpages and code associated with the network 100 in FIG. 1. In step 710, the system 700 can gather pages and code associated with the network 100. In step 720, the LLM 730 can ingest the content and can produce a summary 740 and/or a topic categorization 750 for either the source code associated with the network 100 or webpages associated with the network. In step 760, the system 700 can analyze the summary 740 and the topic categorization 750 to detect duplicates in step 770, to determine page quality in step 780, to determine user-repeated search patterns in step 790, to determine user-refined searches for a similar topic in step 705, and to determine code quality in step 715.

Specifically, in step 770, the system 700 can detect whether the summaries 740 of two different pages and/or source codes are similar within a threshold such as 80% similarity, and whether the topic categorization 750 is the same. If the categorization is the same, and the two different pages and/or source codes are similar within the threshold, the system 700 can determine that the two pages and/or source codes are duplicates of each other and that one page and/or source code should be removed, or that the two pages should be combined into a single page. The LLM 730 can combine the two pages and/or source codes into a single page, or a single source code. If the source codes have been combined or one source code has been deleted, the system 700 can search the source code of the network 100 and replace the calls to the deleted source code with the calls to the remaining source code.

In step 780, the system 700 can analyze the webpages associated with the network 100 to determine page quality including content quality, layout quality, age of the webpage, and image quality. To determine the content quality, the LLM 730 can evaluate the writing and provide a score indicating the quality of the writing. To determine the layout quality, the system 700 can determine whether there is overlapping text and/or images. The older the webpage, the lower the page quality. The lower the resolution of the images, the lower the page quality.

In step 790, the system 700 can determine whether the user performs repeated queries that are similar, and for which the results produce the same webpages, or webpages that are considered duplicates of each other. If that is the case, the system 700 can determine that the quality of the webpages provided as the results of the query is low.

Similarly, in step 705, the system 700 can determine whether the user performs refined searches for the same or a similar topic. If that is the case, the system 700 can determine that the quality of the webpages provided as a result to the user is low. In step 780, 790, 705, if the quality of the page is low, the LLM 730 can suggest fixes to improve the page quality.

In step 715, the system 700 can analyze the code associated with the network 100, and make recommendations for improvements. For example, the system 700 can analyze the code quality by analyzing which libraries the code calls. If a library that the code calls has a known security issue or a known performance issue, the system 700 can suggest a different library that doesn't have the security or the performance issue. Similarly, the system 700 can determine a function of the code, and obtain an approximate execution time for the function. If the code execution time is above the approximate execution time, the system 700 can indicate that the code needs to be optimized, or suggest the optimized code.

In addition, in step 715, the system 700 can recommend the type of hardware on which to deploy the code. For example, the system 700 can predict the amount of traffic that the code, once deployed, needs to handle. Based on the amount of traffic, the system 700 can determine the amount of memory and processing power needed to execute the code and serve the traffic. The system 700 can provide the recommendation for the amount of memory and processing power required to deploy the code. The memory of the processing power can be served by a third party such as a Google or Amazon cloud service.

In step 725, the system 700 can recommend an action to perform. For example, in step 735, the system 700 can recommend a rewritten page and/or a rewritten code ready to deploy, while in step 745, the system can recommend a new page and/or new code ready to deploy.

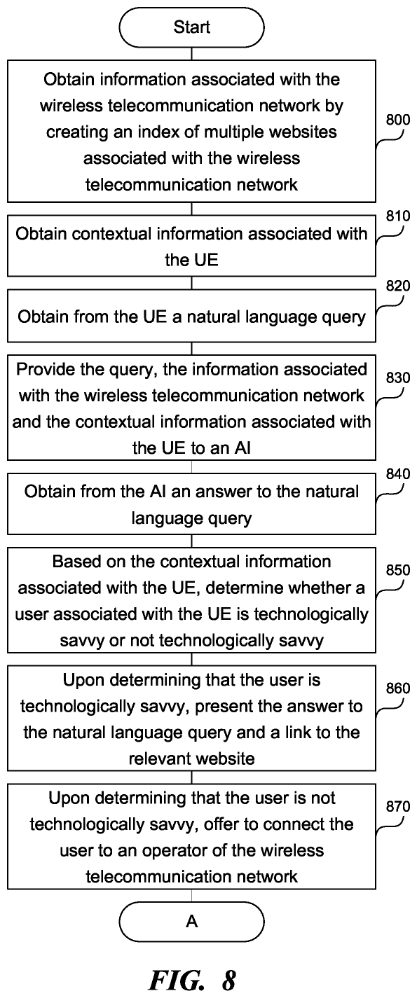

FIG. 8 is a flowchart of a method to provide a user-tailored answer to a query from a UE operating on a wireless telecommunication network. A hardware or software processor executing instructions described in this application can, in step 800, obtain information associated with the wireless telecommunication network by creating an index of multiple websites associated with the wireless telecommunication network.

In step 810, the processor can obtain contextual information associated with the UE including: cell tower identifier (ID) serving the UE, technical capability of the UE, performance information associated with the UE, updates to the UE, browsing history associated with the UE, and/or site deployment information associated with the wireless telecommunication network. Performance information associated with the UE can be processor usage and/or memory usage. Technical capability of the UE can include make and model of the UE. Updates to the UE can include hardware upgrades to the device and/or software updates. Site deployment information can include planned hardware and software changes to the network 100 in FIG. 1.

In step 820, the processor can obtain from the UE a natural language query. In step 830, the processor can provide the query, the information associated with the wireless telecommunication network, and the contextual information associated with the UE to an AI.

In step 840, the processor can obtain from the AI an answer to the natural language query. The answer can be a summary of a relevant website among the multiple websites associated with the wireless telecommunication network.

In step 850, based on the contextual information associated with the UE, the processor can determine whether a user associated with the UE is technologically savvy or not technologically savvy. In step 860, upon determining that the user is technologically savvy, the processor can present the answer to the natural language query and a link to the relevant website among the multiple websites associated with the wireless telecommunication network. In step 870, upon determining that the user is not technologically savvy, the processor can offer to connect the user to an operator of the wireless telecommunication network. The operator can be an AI or a person associated with the network 100.

The processor can evaluate the multiple websites associated with the wireless telecommunication network. For example, the processor can detect duplicated information among the multiple websites. The processor can detect page quality by determining image quality associated with a website among the multiple websites and determining whether information contained on the webpage is outdated. To determine whether the information is outdated, the processor can check the date of the information and the current topic and determine whether there are additional news items associated with the topic, published after the date of the information. Upon determining that the information is duplicated, that the image quality is low, and/or that the webpage is outdated, the processor can suggest an action to perform including removing the website, merging the website with another website among the multiple websites, or updating the website. For example, if the image quality is low, the processor can suggest increasing the quality of the image. If the webpage is duplicated, the processor can suggest removing the duplicated webpage. If the information on the webpage is outdated, the processor can suggest adding the updated information to the webpage.

In another embodiment, to evaluate the multiple websites associated with the wireless telecommunication network, the processor can detect use of repeated search terms by the same user, or a search for a similar topic by the same user. Specifically, the processor can determine content associated with a website among the multiple websites. The processor can determine whether the user performs multiple searches related to the content associated with the website among the multiple websites. The multiple searches can be identical or refined searches. Upon determining that the user performs the multiple searches related to the content associated with the website, the processor can suggest an action to perform including removing the website, merging the website with another website among the multiple websites, or updating the website.

The processor can also evaluate a computer code associated with the wireless telecommunication network. Specifically, the processor can provide the computer code to the AI. The processor can request an AI to provide an indication of security, an indication of performance associated with the computer code, and an indication of hardware needed to execute the computer code. For example, the processor can indicate that the library that the computer code is calling has a known security issue, or a known performance problem. To indicate the hardware needed to execute the computer code, the processor can indicate the amount of CPU or tensor processing unit (TPU) power and memory needed to run the code. The indication of the hardware can indicate how much hardware and software to obtain on a cloud computing platform. Further, the processor can provide the indication of security, the indication of performance associated with the computer code, and the indication of hardware needed to execute the computer code to an operator associated with the computer code.

The processor can use generative AI to create advertisements based on the user context. Specifically, the processor can obtain information associated with the wireless telecommunication network including updates to the wireless telecommunication network and a technical capability associated with a second UE, where the technical capability associated with the second UE is better than the technical capability associated with the UE. For example, the second UE can be a new version of a mobile phone, e.g., a new version of the iPhone. The processor can provide the information associated with the wireless telecommunication network and the contextual information associated with the UE to an AI. The processor can obtain from the AI an advertisement relevant to a user of the UE, and provide the advertisement to the user.

The processor can connect the user to the operator of the network 100 using the most expedient mode of communication such as voice or text chat. Specifically, upon determining that the user is not technologically savvy, the processor can determine a wait time associated with calling the operator and a wait time associated with chatting via text with the operator. The processor can determine whether the wait time associated with calling the operator is less than the wait time associated with chatting via text with the operator. Upon determining that the wait time associated with calling the operator is less than the wait time associated with chatting via text with the operator, the processor can call the operator. Upon determining that the wait time associated with calling the operator is greater than the wait time associated with chatting via text with the operator, the processor can initiate a text chat with the operator.

To determine whether the user associated with the UE is technologically savvy, the processor can obtain a browsing history associated with the UE indicating multiple webpages the UE visited. The processor can determine a portion of the multiple webpages that contains technical content. The processor can determine whether the portion of the multiple webpages that contains technical content exceeds a predetermined threshold, such as 20%. Upon determining that the portion of the multiple webpages that contains technical content exceeds the predetermined threshold, the processor can determine that the user is technologically savvy.

### Computer System

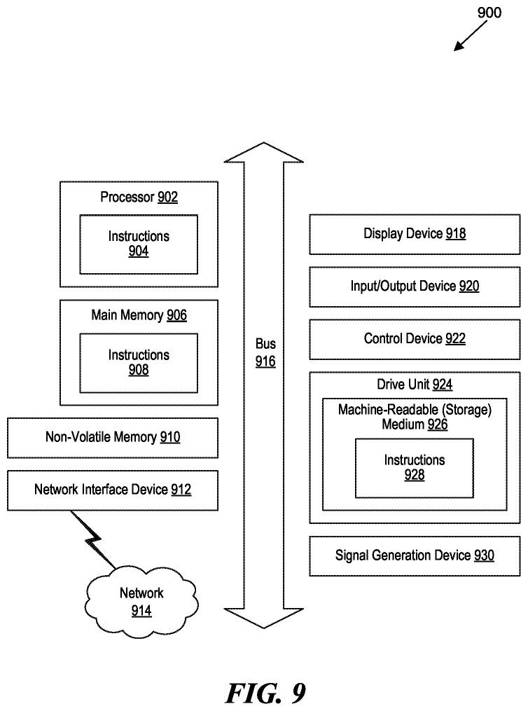

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions provide an answer to a natural language query from a mobile device operating on a wireless telecommunication network, wherein the instructions, when executed by at least one data processor of a system, cause the system to:
obtain information associated with the wireless telecommunication network by creating an index of multiple websites associated with the wireless telecommunication network;
obtain contextual information associated with the mobile device including at least four of: cell tower identifier (ID) serving the mobile device, technical capability of the mobile device, performance information associated with the mobile device, updates to the mobile device, browsing history associated with the mobile device, and site deployment information associated with the wireless telecommunication network;
obtain from the mobile device a natural language query;
provide the query, the information associated with the wireless telecommunication network, and the contextual information associated with the mobile device to a large language model;
obtain from the large language model the answer to the natural language query,
wherein the answer is a summary of a relevant website among the multiple websites associated with the wireless telecommunication network;
based on the contextual information associated with the mobile device, determine whether a user associated with the mobile device is technologically savvy or not technologically savvy;
upon determining that the user is technologically savvy, present the answer to the natural language query and a link to the relevant website among the multiple websites associated with the wireless telecommunication network; and
upon determining that the user is not technologically savvy, offer to connect the user to an operator of the wireless telecommunication network.

2. The non-transitory, computer-readable storage medium of claim 1, comprising instructions to:
obtain information associated with the wireless telecommunication network including updates to the wireless telecommunication network and a technical capability associated with a second mobile device,
wherein the technical capability associated with the second mobile device is better than the technical capability associated with the mobile device;
provide the information associated with the wireless telecommunication network and the contextual information associated with the mobile device to an artificial intelligence (AI);
obtain from the AI an advertisement relevant to the user associated with the mobile device; and
provide the advertisement to the user.

3. The non-transitory, computer-readable storage medium of claim 1, comprising instructions to:
upon determining that the user is not technologically savvy, determine a wait time associated with calling the operator of the wireless telecommunication network and a wait time associated with chatting via text with the operator;
determine whether the wait time associated with calling the operator is less than the wait time associated with chatting via text with the operator;
upon determining that the wait time associated with calling the operator is less than the wait time associated with chatting via text with the operator, call the operator; and
upon determining that the wait time associated with calling the operator is greater than the wait time associated with chatting via text with the operator, initiate a text chat with the operator.

4. The non-transitory, computer-readable storage medium of claim 1, comprising instructions to evaluate the multiple websites associated with the wireless telecommunication network by:
detecting duplicated information among the multiple websites;
detecting page quality by determining image quality associated with a website among the multiple websites, determining whether information contained in the website is outdated; and
suggesting an action to perform including removing the website, merging the website with another website among the multiple websites, or updating the website.

5. The non-transitory, computer-readable storage medium of claim 1, comprising instructions to evaluate the multiple websites associated with the wireless telecommunication network by:
determining content associated with a website among the multiple websites;
determining whether the user performs multiple searches related to the content associated with the website among the multiple websites; and
upon determining that the user performs the multiple searches related to the content associated with the website among the multiple websites, suggesting an action to perform including removing the website, merging the website with another website among the multiple websites, or updating the website.

6. The non-transitory, computer-readable storage medium of claim 1, comprising instructions to evaluate a computer code associated with the wireless telecommunication network by:
providing the computer code to the large language model;
requesting a large language model to provide an indication of security, an indication of performance associated with the computer code, and an indication of hardware needed to execute the computer code; and
providing the indication of security, the indication of performance associated with the computer code, and the indication of hardware needed to execute the computer code to an operator associated with the computer code.

7. The non-transitory, computer-readable storage medium of claim 1, wherein the instructions to determine whether the user associated with the mobile device is technologically savvy comprise instructions to:
obtain the browsing history associated with the mobile device indicating multiple webpages the mobile device visited;
determine a portion of the multiple webpages that contains technical content;
determine whether the portion of the multiple webpages that contains the technical content exceeds a predetermined threshold; and
upon determining that the portion of the multiple webpages that contains technical content exceeds the predetermined threshold, determine that the user is technologically savvy.

8. A method comprising:
obtaining information associated with a wireless telecommunication network by creating an index of multiple websites associated with the wireless telecommunication network;
obtaining contextual information associated with a UE including at least three of: cell tower identifier (ID) serving the UE, technical capability of the UE, performance information associated with the UE, updates to the UE, browsing history associated with the UE, and site deployment information associated with the wireless telecommunication network;
obtaining from the UE a query;
providing the query, the information associated with the wireless telecommunication network, and the contextual information associated with the UE to an artificial intelligence (AI);
obtaining from the AI an answer to the query,
wherein the answer is a summary of a relevant website among the multiple websites associated with the wireless telecommunication network;
based on the contextual information associated with the UE, determining whether a user associated with the UE is technologically savvy or not technologically savvy;
upon determining that the user is technologically savvy, presenting the answer to the query and a link to the relevant website among the multiple websites associated with the wireless telecommunication network; and
upon determining that the user is not technologically savvy, offering to connect the user to an operator of the wireless telecommunication network.

9. The method of claim 8, comprising evaluating the multiple websites associated with the wireless telecommunication network by:
detecting duplicated information among the multiple websites;
detecting page quality by determining image quality associated with a website among the multiple websites, determining whether information contained in the website is outdated; and
suggesting an action to perform including removing the website, merging the website with another website among the multiple websites, or updating the website.

10. The method of claim 8, comprising evaluating the multiple websites associated with the wireless telecommunication network by:
determining content associated with a website among the multiple websites;
determining whether the user performs multiple searches related to the content associated with the website among the multiple websites; and
upon determining that the user performs the multiple searches related to the content associated with the website among the multiple websites, suggesting an action to perform including removing the website, merging the website with another website among the multiple websites, or updating the website.

11. The method of claim 8, comprising evaluating a computer code associated with the wireless telecommunication network by:
requesting the AI to provide an indication of security, an indication of performance associated with the computer code, and an indication of hardware needed to execute the computer code; and
providing the indication of security, the indication of performance associated with the computer code, and the indication of hardware needed to execute the computer code to an operator associated with the computer code.

12. The method of claim 8, comprising:
obtaining information associated with the wireless telecommunication network including updates to the wireless telecommunication network and a technical capability associated with a second UE, wherein the technical capability associated with the second UE is better than the technical capability associated with the UE;
providing the information associated with the wireless telecommunication network and the contextual information associated with the UE to an AI;
obtaining from the AI an advertisement relevant to the user associated with the UE; and
providing the advertisement to the user.

13. The method of claim 8, comprising:
upon determining that the user is not technologically savvy, determining a wait time associated with calling the operator of the wireless telecommunication network and a wait time associated with chatting via text with the operator;
determining whether the wait time associated with calling the operator is less than the wait time associated with chatting via text with the operator;
upon determining that the wait time associated with calling the operator is less than the wait time associated with chatting via text with the operator, calling the operator; and
upon determining that the wait time associated with calling the operator is greater than the wait time associated with chatting via text with the operator, initiating a text chat with the operator.

14. A system comprising:
at least one hardware processor; and
at least one non-transitory memory storing instructions, which, when executed by the at least one hardware processor, cause the system to:
obtain information associated with a wireless telecommunication network by creating an index of multiple websites associated with the wireless telecommunication network;
obtain contextual information associated with a UE including at least three of: cell tower identifier (ID) serving the UE, technical capability of the UE, performance information associated with the UE, updates to the UE, browsing history associated with the UE, and site deployment information associated with the wireless telecommunication network;
obtain from the UE a query;
provide the query, the information associated with the wireless telecommunication network, and the contextual information associated with the UE to an artificial intelligence (AI);
obtain from the AI an answer to the query,
wherein the answer is a summary of a relevant website among the multiple websites associated with the wireless telecommunication network;
based on the contextual information associated with the UE, determine whether a user associated with the UE is technologically savvy or not technologically savvy;
upon determining that the user is technologically savvy, present the answer to the query and a link to the relevant website among the multiple websites associated with the wireless telecommunication network; and
upon determining that the user is not technologically savvy, offer to connect the user to an operator of the wireless telecommunication network.

15. The system of claim 14, comprising instructions to evaluate the multiple websites associated with the wireless telecommunication network by:
detecting duplicated information among the multiple websites;
detecting page quality by determining image quality associated with a website among the multiple websites, determining whether information contained in the website is outdated; and
suggesting an action to perform including removing the website, merging the website with another website among the multiple websites, or updating the website.

16. The system of claim 14, comprising instructions to evaluate the multiple websites associated with the wireless telecommunication network by:
determining content associated with a website among the multiple websites;
determining whether the user performs multiple searches related to the content associated with the website among the multiple websites; and
upon determining that the user performs the multiple searches related to the content associated with the website among the multiple websites, suggesting an action to perform including removing the website, merging the website with another website among the multiple websites, or updating the website.

17. The system of claim 14, comprising instructions to evaluate a computer code associated with the wireless telecommunication network by:
providing the computer code to the AI;
requesting an AI to provide an indication of security, an indication of performance associated with the computer code, and an indication of hardware needed to execute the computer code; and
providing the indication of security, the indication of performance associated with the computer code, and the indication of hardware needed to execute the computer code to an operator associated with the computer code.

18. The system of claim 14, comprising instructions to:
obtain information associated with the wireless telecommunication network including updates to the wireless telecommunication network and a technical capability associated with a second UE, wherein the technical capability associated with the second UE is better than the technical capability associated with the UE;
provide the information associated with the wireless telecommunication network and the contextual information associated with the UE to an AI;
obtain from the AI an advertisement relevant to the user associated with the UE; and
provide the advertisement to the user.

19. The system of claim 14, comprising instructions to:
determine a wait time associated with calling the operator of the wireless telecommunication network and a wait time associated with chatting via text with the operator;
determine whether the wait time associated with calling the operator is less than the wait time associated with chatting via text with the operator;
upon determining that the wait time associated with calling the operator is less than the wait time associated with chatting via text with the operator, call the operator; and
upon determining that the wait time associated with calling the operator is greater than the wait time associated with chatting via text with the operator, initiate a text chat with the operator.

20. The system of claim 14, wherein the instructions to determine whether the user associated with the UE is technologically savvy comprise instructions to:
obtain a browsing history associated with the UE indicating multiple webpages the UE visited;
determine a portion of the multiple webpages that contains technical content;
determine whether the portion of the multiple webpages that contains technical content exceeds a predetermined threshold; and
upon determining that the portion of the multiple webpages that contains technical content exceeds the predetermined threshold, determine that the user is technologically savvy.
